(19) United States
(12) Patent Application Publication
(10) Pub. No.: US 2014/0342182 A1
(43) Pub. Date: Nov. 20, 2014

(54) GALVANNEALED STEEL SHEET HAVING HIGH CORROSION RESISTANCE AFTER PAINTING

(71) Applicant: JFE STEEL CORPORATION, Tokyo (JP)

(72) Inventors: Mai Miyata, Tokyo (JP); Yoshitsugu Suzuki, Tokyo (JP)

(21) Appl. No.: 14/344,376

(22) PCT Filed: Sep. 20, 2012
(86) PCT No.: PCT/JP2012/005959

§ 371 Date: Mar. 12, 2014

(30) Foreign Application Priority Data
Sep. 20, 2011 (JP) 2011-204415

(51) Int. Cl. B32B 15/01; C23C 2/06; C23C 2/28

(52) U.S. Cl. CPC B32B 15/013; C23C 2/28; C23C 2/06
USPC 428/659

(57) ABSTRACT

A galvannealed steel sheet having high corrosion resistance after painting, includes, on a mass percent basis, C: 0.05% to 0.30%, Si: 1.0% to 3.0%, Mn: 0.5% to 3.0%, Al: 0.01% to 3.00%, S: 0.001% to 0.010%, and P: 0.001% to 0.100% as chemical components, the remainder being Fe and incidental impurities, wherein the steel sheet includes a galvannealed layer on a surface thereof, the galvannealed layer containing Fe: 7% to 15% and Al: 0.02% to 0.30% and a remainder being Zn and incidental impurities, the percentage of exposed Zn metal of the galvannealed layer surface being 20% or more.

### TECHNICAL FIELD

This disclosure relates to a galvannealed steel sheet having high corrosion resistance after painting based on a high-strength steel sheet containing Si and a method of manufacturing the galvannealed steel sheet.

### BACKGROUND

In recent years, surface-treated steel sheets manufactured by using rustproofing steel sheets as materials, particularly galvannealed steel sheets, which are excellent in rustproofness, have been used in the fields of automobiles, household electrical appliances, and construction materials. In particular, the number of rustproof high-strength galvannealed steel sheets used in the automotive field is increasing because, from the standpoint of improving the mileage and crash safety of automobiles, the trend of increasing the strength and reducing the thickness of automobile body materials and thereby reducing the weight and increasing the strength of automotive bodies encourages the application of high-strength steel sheets to automobiles.

In the application of high-strength galvannealed steel sheets to the automotive field, corrosion resistance after painting is as important as the rustproof properties. Since automotive steel sheets are painted and then used, they are generally subjected to a chemical conversion treatment called “phosphating” before painting. However, steel sheets having poor chemical conversion treatability have an uncovered region in which no crystals grow during chemical conversion, and have painting defects in the uncovered region. This results in low corrosion resistance after painting.

It is known that this problem tends to occur particularly in Si-rich steel sheets. To produce galvannealed steel sheets, steel sheets are generally subjected to hot-dip coating and are heat-treated in air to cause iron of the steel sheets, i.e. the substrate steel sheets, to diffuse into a galvanized layer, thereby forming an alloy. Because of their low alloying reaction rate, Si-rich steel sheets require high alloying temperatures. This results in formation of a Zn oxide layer having an increased thickness on the surface of coating during the alloying reaction. The Zn oxide layer repels a chemical conversion treatment liquid and adversely affects chemical conversion treatability. This results in low corrosion resistance after painting.

As an example of efforts to improve the chemical conversion treatability of galvannealed steel sheets, Japanese Patent No. 3644402 discloses a galvannealed steel sheet that has a flat portion in which an oxide layer having a thickness of 10 nm or more is formed on the coated layer surface, wherein the Zn/Al ratio (at %) of the flat portion surface layer is 2.0 to 8.0. In the technique described in Japanese Patent No. 3644402, a thin portion of the oxide film serves as the starting point of the formation of crystals growing during chemical conversion and thereby improves chemical conversion treatability. Thus, when the oxide film entirely has a large thickness as in Si-rich steel sheets, this technique has a low improvement effect.

It could therefore be helpful to provide a galvannealed steel sheet having high corrosion resistance after painting based on a high-strength steel sheet containing Si and a method of manufacturing the galvannealed steel sheet.

### SUMMARY

We thus provide:

[1] A galvannealed steel sheet having high corrosion resistance after painting containing, on a mass percent basis, C: 0.05% to 0.30%, Si: 1.0% to 3.0%, Mn: 0.5% to 3.0%, Al: 0.01% to 3.00%, S: 0.001% to 0.010%, and P: 0.001% to 0.100% as chemical components, the remainder being Fe and incidental impurities, wherein the steel sheet includes a galvannealed layer on the surface thereof, the galvannealed layer containing Fe: 7% to 15% and Al: 0.02% to 0.30% and a remainder being Zn and incidental impurities, the percentage of exposed Zn metal of the galvannealed layer surface being 20% or more.

[2] The galvannealed steel sheet having high corrosion resistance after painting according to [1], further containing at least one element selected from Cr: 0.1% to 1.0%, Mo: 0.1% to 1.0%, Ti: 0.01% to 0.10%, Nb: 0.01% to 0.10%, and B: 0.0005% to 0.0050% on a mass percent basis.

(The percentages with respect to steel components are based on mass percentage.)

Our galvannealed steel sheets thus have high corrosion resistance after painting.

### DETAILED DESCRIPTION

In galvannealed steel sheets based on Si-rich steel sheets, a Zn oxide layer formed on the coated layer surface adversely affects chemical conversion treatability and tends to lower corrosion resistance after painting.

We studied the relationship between the state of Zn oxide on the surface of coating before a chemical conversion treatment and corrosion resistance after painting. We found that corrosion resistance after painting tends to deteriorate with increasing amount of Zn oxide. However, corrosion resistance after painting varied in some cases, even if there were substantially the same amounts of Zn oxide. A detailed examination of the surface state showed that a sample having high corrosion resistance after painting had a low fraction of surface coverage with Zn oxide. In other words, corrosion resistance after painting tends to be improved with increasing percentage of exposed Zn metal of the galvannealed layer surface. The term “Zn metal”, as used herein, refers to Zn detected as a metal by XPS after a natural oxidation film of Zn is removed.

First, a galvannealed layer surface was sputtered to remove a Zn oxide having a thickness in the range of 5 to 15 nm. The relationship between the percentage of exposed Zn metal and corrosion resistance after painting was studied on the basis of the percentage of exposed Zn metal as measured by XPS. As a result, we found that corrosion resistance after painting was satisfactory when the percentage of exposed Zn metal was 20% or more.

Furthermore, the percentage of exposed Zn metal was measured in galvannealed steel sheets based on steel sheets having different Si contents. As a result, we considered that the percentage of exposed Zn metal tends to decrease with increasing Si content of the steel sheets. This is probably because an increase in Si content resulted in an increased alloying temperature and the formation of a thick Zn oxide layer. Thus, in Si-rich steel sheets, to increase the percentage of exposed Zn metal and improve corrosion resistance after painting, it is necessary to suppress the growth of a Zn oxide layer. We also studied various methods of suppressing the growth of a Zn oxide layer and found it effective to blow an inert gas over the surface of a steel sheet during an alloying heat treatment. When no Zn oxide layer is formed during the alloying heat treatment, Zn may evaporate because of its low vapor pressure. Thus, formation of a certain amount of Zn oxide layer is indispensable. Also in this regard, it is effective to blow an inert gas over the surface of a steel sheet during the alloying heat treatment.

Details of our steel sheets and methods will be described below.

First, the chemical components will be described below.

C: 0.05% to 0.30%

C is an element that can stabilize an austenite phase and is also an element required to increase the strength of the steel sheet. It is difficult to maintain the strength of the steel sheet at a C content of less than 0.05%. A C content of more than 0.30% results in poor weldability of the steel sheet. Thus, the C content is 0.05% to 0.30%.

Si: 1.0% to 3.0%

Si concentrates solid solution C of a ferrite phase in an austenite phase and increases the temper softening resistance of steel, thereby improving formability of the steel sheet. This effect requires a Si content of 1.0% or more. Since Si is an oxidizable element, Si forms an oxide on the surface of the steel sheet during recrystallization annealing. Since Si significantly delays alloying in an alloying process after hot-dip coating, the alloying treatment must be performed at an increased alloying temperature. A Si content of more than 3.0% may result in no improvement in corrosion resistance after painting. Thus, the Si content is 1.0% to 3.0%.

Mn: 0.5% to 3.0%

Mn is an element useful in improving quenching hardenability and increasing the strength of the steel sheet. These effects require a Mn content of 0.5% or more. A Mn content of more than 3.0% results in the segregation of Mn and poor formability. Thus, the Mn content is 0.5% to 3.0%.

Al: 0.01% to 3.00%

Al is an element added complementarily to Si. An Al content is 0.01% or more. However, an Al content of more than 3.00% results in poor weldability and an imbalance between strength and ductility. Thus, the Al content is 0.01% to 3.00%.

S: 0.001% to 0.010%

S is an inevitable element of steel and forms a plate-like inclusion MnS, which impairs formability after cold rolling. MnS is not formed at a S content of 0.010% or less. An excessive reduction in S content increases desulfurization costs in a steel making process. Thus, the S content is 0.001% to 0.010%.

P: 0.001% to 0.100%

P is an inevitable element of steel and an element that contributes to improved strength. On the other hand, P is an element that impairs weldability. A P content of more than 0.100% results in markedly poor weldability. An excessive reduction in P content increases manufacturing costs in a steel making process. Thus, the P content is 0.001% to 0.100%.

The remainder are Fe and incidental impurities.

One or two or more of the following components may be contained if necessary.

Cr: 0.1% to 1.0%

Cr is an element effective in improving the quenching hardenability of steel. Cr induces solid-solution hardening of a ferrite phase and reduces the difference in hardness between a martensite phase and the ferrite phase, thus effectively contributing to improved formability. Such an effect requires a Cr content of 0.1% or more. However, a Cr content of more than 1.0% results in saturation of the effect and, instead, a significant deterioration in surface quality. Thus, if necessary, the Cr content is 0.1% to 1.0%.

Mo: 0.1% to 1.0%

Mo is an element effective in improving quenching hardenability of steel and is also an element that induces temper secondary hardening. These effects require a Mo content of 0.1% or more. However, a Mo content of more than 1.0% results in saturation of the effects and an increase in cost. Thus, if necessary, the Mo content is 0.1% to 1.0%.

Ti: 0.01% to 0.10%

Ti forms fine carbide or fine nitride with C or N in steel and is effective to form a fine-grained structure and precipitation hardening after annealing. These effects require a Ti content of 0.01% or more. However, a Ti content of more than 0.10% results in saturation of the effects. Thus, if necessary, the Ti content is 0.01% to 0.10%.

Nb: 0.01% to 0.10%

Nb is an element that contributes to improved strength through solid solution strengthening or precipitation hardening.

This effect requires a Nb content of 0.01% or more. However, a Nb content of more than 0.10% results in low ductility of ferrite and poor processability. Thus, if necessary, the Nb content is 0.01% to 0.10%.

B: 0.0005% to 0.0050%

B is required to improve quenching hardenability, suppress formation of ferrite during cooling after annealing, and produce a desired amount of martensite. These effects require a B content of 0.0005% or more. A B content of more than 0.0050% results in saturation of the effects. Thus, if necessary, the B content is 0.0005% to 0.0050%.

Next, the galvannealed layer will be described below.

The galvannealed layer contains Fe: 7% to 15% and Al: 0.02% to 0.30% and a remainder of Zn and incidental impurities.

The galvannealed layer is a coated layer mainly composed of an Fe—Zn alloy formed by diffusion of Fe of the base material into a Zn coating through an alloying reaction. An Fe content of less than 7% results in a thick residual Zn layer that is not alloyed in the vicinity of the surface of the coated layer and impairs press formability. An Fe content of more than 15% results in poor adhesion of the coating because of formation of a large amount of brittle alloy layer at the interface between the base material and the coated layer. Thus, the Fe content is 7% to 15%.

Since a Zn bath contains Al to suppress alloying reactions in the bath, Al constitutes 0.02% to 0.30% of the coating. Furthermore, since various elements added to the steel sheet dissolve partly in the Zn bath, the coated layer unavoidably contains these elements.

The percentage of exposed Zn metal of the galvannealed layer surface is 20% or more.

A thin Zn and Al oxide layer derived from the bath components is formed on the surface layer of the galvannealed steel sheet. When the percentage of exposed Zn metal of the galvannealed layer surface is less than 20%, corrosion resistance after painting is deteriorated. Preferably, the percentage of exposed Zn metal of the galvannealed layer surface is 40% or more. To improve adhesion after painting, the exposed portion of Zn metal should not be localized in a portion of the coated layer surface. Thus, for example, the percentage of exposed Zn metal is preferably 20% or more in any 500 μm×500 μm area on the coated layer surface.

The percentage of exposed Zn metal of the galvannealed layer surface can be determined from the intensity ratio between zinc oxide and zinc metal in an AES spectrum. More specifically, a zinc oxide spectrum at approximately 992 eV is separated from a zinc metal spectrum at approximately 996 eV on the basis of a standard sample spectrum to quantify the ratio of zinc metal to zinc oxide. Thus, the percentage of zinc metal is obtained and taken as the percentage of exposed Zn metal.

The percentage of exposed Zn metal of the galvannealed layer surface can be increased to 20% or more, for example, by rolling the steel sheet with a dull roll having a surface roughness Ra of 2.0 μm or more at a rolling reduction of 0.3% or more and 0.8% or less and then rolling the resultant steel sheet with a bright roll having a surface roughness Ra of 0.1 μm or less at a rolling reduction of 0.4% or more and 1.0% or less in skin pass rolling. The rolling reduction with the bright roll must be greater than the rolling reduction with the dull roll. We believe that rolling with the bright roll immediately after rolling with the dull roll can promote the removal of the surface oxide film and thereby the percentage of exposed Zn metal is increased.

Next, a method of manufacturing the galvannealed steel sheet will be described below.

A galvannealed steel sheet can be manufactured under any conditions, provided that the galvannealed steel sheet is mainly composed of the chemical components described above. For example, a slab containing the above composition is hot-rolled, pickled if necessary, and then cold-rolled.

The resulting steel sheet is then annealed, coated, and subjected to an alloying treatment in a continuous hot-dip galvannealing line. The annealing conditions in the hot-dip galvannealing line are not particularly limited and may be as described below, for example.

First, the steel sheet is heated to a temperature of 400° C. to 850° C. in an atmosphere containing O₂: 0.01% to 20% by volume and H₂O: 1% to 50% by volume, heated to a temperature of 750° C. to 900° C. in an atmosphere containing H₂: 1% to 50% by volume and having a dew point of 0° C. or less, and then cooled.

Heating in an atmosphere containing O₂ and H₂O is intended to form an Fe oxide film on the surface of the steel sheet. Annealing of a Si-rich steel sheet in a common reducing atmosphere may form Si oxide on the surface of the steel sheet, and Si oxide may repel zinc and thereby bare spots are formed. To avoid this, preferably, Fe oxide is formed on the surface of the steel sheet before annealing and is reduced during annealing to cover the surface of the steel sheet with reduced Fe after annealing.

When the O₂ content of the atmosphere is less than 0.01% by volume, Fe is not oxidized. Thus, the O₂ content is preferably 0.01% by volume or more. From an economic point of view, the O₂ content is preferably smaller than or equal to the atmospheric level, that is, 20% by volume or less. Preferably, the H₂O content is 1% by volume or more to promote oxidation. Preferably, the H₂O content is 50% by volume or less in terms of humidification cost. A steel sheet temperature of less than 400° C. results in insufficient oxidation. A steel sheet temperature of more than 850° C. results in excessive oxidation and the occurrence of flaws due to pickup with a roll in an annealing furnace. Thus, the steel sheet temperature preferably is 400° C. to 850° C.

Heating in an atmosphere containing H₂ is intended for recrystallization annealing of the steel sheet and reduction of Fe oxide formed on the surface of the steel sheet in the upstream process. A H₂ content of less than 1% by volume or a dew point of more than 0° C. may result in insufficient reduction of Fe oxide and poor adhesion of the coating due to residual Fe oxide. A H₂ content of more than 50% by volume results in an increased cost. The lower limit of the dew point is not particularly limited and is preferably −60° C. or more because a dew point of less than −60° C. is industrially difficult to achieve.

A steel sheet temperature of less than 750° C. may result in insufficient relief of strain resulting from cold rolling, the presence of residual unrecovered ferrite, and poor processability. A steel sheet temperature of more than 900° C. requires a high heating cost.

After annealing, the steel sheet is cooled and immersed in a hot-dip galvanizing bath at a bath temperature of 440° C. to 550° C. at an Al concentration of 0.10% to 0.20% to perform hot-dip galvanizing. The galvanized steel sheet is then subjected to an alloying treatment at a temperature of 480° C. to 580° C.

A zinc bath temperature of less than 440° C. may result in solidification of Zn in a portion of the coating bath having large temperature variations. A zinc bath temperature of more than 550° C. may result in rapid evaporation and cause operational problems such as high operation costs and deposition of vaporized Zn onto an inside of a furnace. This also tends to result in over-alloying because alloying proceeds during hot-dip galvanizing.

When the Al concentration of the bath is less than 0.10%, a large amount of Γ phase is generated and may cause a poor powdering property. When the Al concentration of the bath is more than 0.20%, Fe—Zn alloying sometimes does not proceed.

An alloying treatment temperature of less than 480° C. results in slow alloying. An alloying treatment temperature of more than 580° C. may result in excessive formation of a hard and brittle Zn—Fe alloy layer at the interface with the base steel due to over-alloying and may cause poor adhesion of the coating. This may also result in decomposition of a retained austenite phase and may cause a poor strength-ductility balance.

The amount of coating is not particularly limited and is preferably 10 g/m² or more (per side) in consideration of corrosion resistance and controllability of the amount of coating. A large amount of coating results in poor adhesion. Thus, the amount of coating is preferably 120 g/m² or less (per side).

When the alloying treatment temperature is more than 520° C., an inert gas is preferably blown over the surface of coating at a temperature of 500° C. or more. An alloying treatment at high temperatures may result in formation of a thick Zn oxide film and a low percentage of exposed Zn metal. To avoid this, an inert gas is blown over the surface of coating to reduce the oxygen supply to the surface of coating and retard the growth of the Zn oxide film. Since a temperature of less than 500° C. may result in insufficient formation of the Zn oxide film, reduction of oxygen supply may result in evaporation of Zn because of its low vapor pressure. Thus, an inert gas is preferably blown over the surface of coating at a temperature of 500° C. or more.

### EXAMPLES

Our steel sheets and methods will be more specifically described in the following examples.

A slab having a steel composition shown in Table 1 was heated in a heating furnace at 1260° C. for 60 minutes, subsequently hot-rolled to 2.8 mm, and coiled at 540° C. Mill scale was then removed by pickling, and the steel sheet cold-rolled to 1.6 mm. The steel sheet was then heated to 700° C. in a furnace in an oxidizing atmosphere having an O₂ content of 0.01% to 5.0% by volume, then heated to and maintained at 850° C. in an reducing atmosphere having a H₂ content of 5% to 15% by volume and a dew point of less than 0° C., and cooled to 480° C. The atmosphere in the furnace could be altered, and the gas flow rate could be maintained constant during heat treatment.

Subsequently, the steel sheet was subjected to hot-dip galvanizing in a Zn bath containing Al at 460° C. to produce a galvanized steel sheet. The Al concentration of the bath was 0.14%. The amount of coating was adjusted to be 40 g/m² per side using gas wiping. Subsequently, the steel sheet was subjected to an alloying treatment at a temperature of 480° C. to 580° C. to produce a galvannealed steel sheet with a galvannealed layer having an Fe content of 9% to 13%. In the alloying treatment, when the alloying temperature was more than 520° C., N₂ or Ar gas was blown over the galvanized layer surface in a steel sheet temperature of 500° C. or more to retard growth of a Zn oxide layer. The galvannealed steel sheet was then subjected to skin pass rolling under conditions shown in Table 2.

The galvannealed steel sheet obtained above was subjected to measurement of the percentage of exposed Zn metal and evaluation of corrosion resistance after painting.

The surface of the obtained steel sheet was analyzed by XPS. The percentage of exposed Zn metal was determined by calculating the ratio of Zn metal to oxide Zn on the surface of the steel sheet from the XPS profile.

The galvannealed steel sheet was subjected to a chemical conversion treatment and electrodeposition coating. The sample surface was then slit for SST (Salt water spray test). The blister width along the slit after SST was compared with the blister width of reference mild steel to evaluate corrosion resistance. Double circles and circles indicate acceptable levels.

Double circle: substantially the same blister width as mild steel

Circle: less than or equal to 1.5 times the blister width of mild steel

Cross: more than 1.5 times the blister width of mild steel

Table 2 shows the results together with manufacturing conditions

TABLE 1
(mass %)

| Symbol for | | | | | | | | | | | |
|---|---|---|---|---|---|---|---|---|---|---|---|
| steel sheet | C | Si | Mn | Al | S | P | Cr | Mo | Ti | Nb | B |
| A | 0.08 | 1.5 | 1.4 | 0.03 | 0.005 | 0.012 | — | — | — | — | — |
| B | 0.08 | 1.5 | 1.4 | 0.03 | 0.005 | 0.010 | 0.2 | — | — | — | — |
| C | 0.12 | 1.4 | 1.9 | 0.03 | 0.005 | 0.013 | — | — | — | — | — |
| D | 0.12 | 1.4 | 1.9 | 0.03 | 0.005 | 0.013 | — | 0.2 | — | — | 0.0010 |
| E | 0.08 | 1.0 | 2.1 | 0.03 | 0.005 | 0.011 | — | — | — | — | — |
| F | 0.08 | 1.0 | 2.1 | 0.03 | 0.005 | 0.010 | 0.1 | — | — | — | — |
| G | 0.08 | 1.0 | 2.1 | 0.03 | 0.005 | 0.015 | — | — | 0.05 | 0.03 | — |
| H | 0.09 | 2.3 | 1.4 | 0.02 | 0.003 | 0.020 | — | — | — | — | — |
| I | 0.12 | 3.5 | 1.5 | 0.02 | 0.005 | 0.018 | — | — | — | — | — |

TABLE 2

| | | | | Method for | | | | | | | | | |
|---|---|---|---|---|---|---|---|---|---|---|---|---|---|
| | | Alloy- | Fe content | suppressing | First skin pass rolling | | | Second skin pass rolling | | | | Corrosion | |
| | | ing tem- | of galvan- | growth of | Reduction roll | | Rolling | Reduction roll | | Rolling | Percentage | resistance | |
| | Steel | pera- | nealed | Zn oxide | Roll | Roughness | reduc- | Roll | Roughness | reduc- | of exposed | after | |
| No | sheet | ture/° C. | layer/% | layer | type | Ra/μm | tion/% | type | Ra/μm | tion/% | Zn/% | painting | Note |
| 31 | A | 540 | 9.8 | — | Dull | 2.2 | 0.4 | Bright | 0.1 | 0.5 | 40 | ◯ | Example |
| 2 | A | 540 | 10.1 | — | Dull | 2.4 | 0.4 | Bright | 0.1 | 0.5 | 50 | ⊙ | Example |
| 3 | A | 540 | 10.3 | — | Dull | 2.6 | 0.4 | Bright | 0.1 | 0.5 | 60 | ⊙ | Example |
| 4 | A | 540 | 9.5 | — | Dull | 2.2 | 0.6 | Bright | 0.1 | 0.5 | 60 | ⊙ | Example |
| 5 | A | 560 | 11.8 | — | Dull | 2.2 | 0.4 | Bright | 0.1 | 0.7 | 50 | ⊙ | Example |
| 6 | A | 540 | 10.5 | N₂ gas blow | Dull | 2.2 | 0.4 | Bright | 0.1 | 0.5 | 50 | ⊙ | Example |
| 7 | A | 540 | 11.2 | N₂ gas blow | Dull | 2.4 | 0.4 | Bright | 0.1 | 0.5 | 60 | ⊙ | Example |
| 8 | A | 560 | 11.5 | N₂ gas blow | Dull | 2.6 | 0.4 | Bright | 0.1 | 0.5 | 70 | ⊙ | Example |
| 9 | A | 540 | 10.8 | N₂ gas blow | Dull | 2.2 | 0.6 | Bright | 0.1 | 0.7 | 60 | ⊙ | Example |
| 10 | A | 570 | 12.2 | N₂ gas blow | Dull | 2.2 | 0.4 | Bright | 0.1 | 0.5 | 30 | ◯ | Example |
| 11 | A | 500 | 9.2 | — | Dull | 2.2 | 0.2 | Bright | 0.1 | 0.3 | 15 | X | Compar- |
| | | | | | | | | | | | | | ative |
| | | | | | | | | | | | | | example |
| 12 | A | 540 | 10.5 | — | Bright | 0.1 | 0.5 | Dull | 2.2 | 0.4 | 15 | X | Compar- |
| | | | | | | | | | | | | | ative |
| | | | | | | | | | | | | | example |
| 13 | A | 560 | 11.6 | — | Dull | 2.2 | 0.8 | Bright | 0.1 | 1 | 90 | ⊙ | Example |
| 14 | A | 540 | 10.2 | — | Dull | 2.2 | 0.9 | — | — | — | 15 | X | Compar- |
| | | | | | | | | | | | | | ative |
| | | | | | | | | | | | | | example |
| 15 | A | 540 | 10.3 | N₂ gas blow | Dull | 2.2 | 0.9 | — | — | — | 18 | X | Compar- |
| | | | | | | | | | | | | | ative |
| | | | | | | | | | | | | | example |
| 16 | A | 540 | 11.5 | — | Bright | 0.1 | 0.9 | — | — | — | 13 | X | Compar- |
| | | | | | | | | | | | | | ative |
| | | | | | | | | | | | | | example |
| 17 | B | 540 | 12.3 | — | Dull | 2.2 | 0.4 | Bright | 0.1 | 0.5 | 40 | ◯ | Example |
| 18 | C | 540 | 11.3 | — | Dull | 2.2 | 0.4 | Bright | 0.1 | 0.5 | 50 | ⊙ | Example |
| 19 | D | 540 | 12.8 | — | Dull | 2.2 | 0.4 | Bright | 0.1 | 0.5 | 50 | ⊙ | Example |
| 20 | E | 540 | 11.4 | — | Dull | 2.2 | 0.4 | Bright | 0.1 | 0.5 | 40 | ◯ | Example |
| 21 | F | 560 | 12.3 | N₂ gas blow | Dull | 2.2 | 0.4 | Bright | 0.1 | 0.5 | 60 | ⊙ | Example |
| 22 | G | 540 | 10.8 | — | Dull | 2.2 | 0.4 | Bright | 0.1 | 0.5 | 50 | ⊙ | Example |
| 23 | H | 560 | 11.5 | N₂ gas blow | Dull | 2.2 | 0.4 | Bright | 0.1 | 0.5 | 30 | ◯ | Example |
| 24 | I | 560 | 9.8 | — | Dull | 2.2 | 0.4 | Bright | 0.1 | 0.5 | 10 | X | Compar- |
| | | | | | | | | | | | | | ative |
| | | | | | | | | | | | | | example |
| 25 | I | 560 | 11.5 | N₂ gas blow | Dull | 2.2 | 0.4 | Bright | 0.1 | 0.5 | 15 | X | Compar- |
| | | | | | | | | | | | | | ative |
| | | | | | | | | | | | | | example |

Table 2 shows that our galvannealed steel sheets according to the examples had high corrosion resistance after painting irrespective of the inclusion of Si. In contrast, the galvannealed steel sheets according to the comparative examples had low corrosion resistance after painting.

### INDUSTRIAL APPLICABILITY

Our galvannealed steel sheets have high corrosion resistance after painting and are expected to be widely used in the automotive field and other fields.

1.-2. (canceled)

3. A galvannealed steel sheet having high corrosion resistance after painting, comprising, on a mass percent basis, C: 0.05% to 0.30%, Si: 1.0% to 3.0%, Mn: 0.5% to 3.0%, Al: 0.01% to 3.00%, S: 0.001% to 0.010%, and P: 0.001% to 0.100% as chemical components, the remainder being Fe and incidental impurities, wherein the steel sheet includes a galvannealed layer on a surface thereof, the galvannealed layer containing Fe: 7% to 15% and Al: 0.02% to 0.30% and a remainder being Zn and incidental impurities, the percentage of exposed Zn metal of the galvannealed layer surface being 20% or more.

4. The galvannealed steel sheet according to claim 3, further comprising at least one element selected from Cr: 0.1% to 1.0%, Mo: 0.1% to 1.0%, Ti: 0.01% to 0.10%, Nb: 0.01% to 0.10%, and B: 0.0005% to 0.0050% on a mass percent basis.
